(19) United States
(12) Patent Application Publication
(10) Pub. No.: US 2004/0166259 A1
(43) Pub. Date: Aug. 26, 2004

(54) Packaging including enhanced sealing of uncoated medical-grade spunbounded olefin substrates

(76) Inventor: John Merritt, Clinton, CT (US)

Correspondence Address: FISH & RICHARDSON P.C., 5000 BANK ONE CENTER, 1717 MAIN STREET, DALLAS, TX, 75201, US

(21) Appl. No.: 10/748,018

(22) Filed: Dec. 30, 2003

Related U.S. Application Data
(60) Provisional application No. 60/437,496, filed on Dec. 30, 2002.

(51) Int. Cl. F16L 1/00

(52) U.S. Cl. 428/34.1; 428/35.7

(57) ABSTRACT

A package for containing sterile packed items is formed from the joining of a first sheet of material and a second sheet of material. The package formed comprises a cavity for containing at least one item, a first group of sealing elements and a second set of sealing elements. The two groups of sealing elements have relative size(s), shape(s) and placement(s) to provide a desired level of seal and mechanical cohesion while reducing fiber tear out that could contaminate the contained items.

### CROSS-REFERENCE TO RELATED APPLICATIONS

This application is related to co-pending provisional application serial No. 60/437,496, filed Dec. 30, 2002, which is incorporated herein by reference for any and all purposes.

### TECHNICAL FIELD

This invention relates to packaging, and, more particularly, to packaging for sterilized products, such as surgical instruments and the like, formed in part from non-paper products, such as olefins.

### BACKGROUND

Certain items, such as surgical instruments, syringes, catheters, and the like, are routinely sterilized and packed (sterile-packed) at the manufacturer primarily to provide convenience of use. Sterile-packed items are available for immediate use upon removal from the packaging (i.e., no sterilization is required following removal but prior to use). Additionally, use of pre-sterilization provides a measure of protection against re-use of the packaged items. If the sterilization step occurred with the end user, there could be a greater incidence of users re-sterilizing and reusing certain products.

After the items are secured within the packaging, the packaging is subjected to a sterilization process. Sterilization can occur in one of a number of ways, including via application of heat (steam), gases, and combinations thereof. While historically most sterilization has been carried out through the application of heat (e.g., steam), elevated temperature can have deleterious affects on both the constituent components of the packaging, as well as on the item(s) contained therein. For example, many medicines and surgical instruments are adversely affected when exposed to elevated temperatures.

When heat is to be avoided, sterilization is accomplished most often via the introduction of a gas, for example a germicidal gas. To accomplish sterilization via such gas, the packages to be sterilized are placed in an enclosed container and the air within the packages is replaced to some degree by a germicidal gas. The gas is commonly introduced into the container by alternate application of a partial vacuum and the use of super-atmospheric pressure.

Once the gas is introduced, a process of gas exchange occurs between the environment external to packages and the environment within the packages. One or more materials used for the packaging are selected for gas permeability characteristics, allowing the gas exchange to occur through the packaging material. The introduction of such gas not only eliminates the level of microorganisms then-existing within the packages, but the quantities of residual gas retained within the packages provide adequate protection against renewed bacterial contamination within the packages until the packages are used or consumed, assuming the package is adequately sealed.

It is now known to join a strip of paper and a strip of plastic foil sheeting together, preferably by sealing, to form a container exhibiting an acceptable level of seal to contain sterile- packed items. Using prior art methods, there is a minimum width (typically approximately 5 millimeters) of joined edges (i.e., perimeter regions of the package formed) of the sheeting materials required to produce a sufficient seal. A tight seal is formed by pressing together the edges of the sheeting material, with optional application of heat.

There exists a balancing of competing interests when forming a seal. On the one hand, the strength of the seal should be sufficient to retain the sterilized interior environment of the package. At the same time, the strength of seal should not be so great that opening the package requires tools or extraordinary effort. Ideally, when access to the sterile-packed items is desired the user should be able to peel the strips of materials apart to reveal the packaged items. If needed, a tab or similar region of material can be used to facilitate this process.

Another factor that must be considered in peeling the sheets of materials apart to open the sterile package is whether fibers from one or both materials will be dislodged during the peeling. A seal that is too tight can cause fibers associated with the material(s) to be ripped out as the sheets are being separated. Once dislodged, the loose fibers can fall inside the package and compromise the sterility/use of any items contained therein. For example, loose fibers coming into contact with surgical instruments can cause inflammation in patients upon whom such instruments are used. Therefore, ideally the bond or seal between the strip paper and the strip of foil sheeting is made such that while ease of “peelability” is retained, no loose fibers result during peeling.

There are a number of disadvantages associated with use of paper and paper-like materials for packaging used for sterile-packed items. For example, use of traditional agents, such as glue and the like, to increase the cohesion of the fiber-bond of strip paper (thereby reducing the occurrence of loose fibers upon peeling) precludes the level of gas permeability needed for sterilization. Likewise, use of materials likely to enhance gas permeability can also increase the chance that loose fibers will be produced upon peeling.

As a result of the foregoing, and other disadvantages, use of non-paper materials, like polyolefins, for packaging of sterile-packed items is desired because such materials provide superior inner bond strength, superior tear resistance, low fiber release and good porosity, when compared with paper materials. As set forth more completely in U.S. Pat. No. 4,630,729, assigned to Firma Dixie Union Verpackungen, a related company to assignee, the complete disclosure of which is incorporated herein by reference for any and all purposes, it is also known to seal a package consisting of a strip of plastic foil or sheeting, and a strip of paper, whereby the two strips are sealed together at their margins, so as to permit opening of the package by a peeling action, wherein the seal consists of two groups of sealing elements, group 1 (one) of which includes small dimension seals to ensure the integrity of the resulting seal, and group 2 (two) of which includes linear seals with restricted dimensions (width) that are arranged such that they run transverse to the direction of the peel. The arranging of the group 2 (two) seals combines a high degree of mechanical strength with ease of peeling, minimizing fiber tear-out.

### SUMMARY

It is the object of the present invention to improve on a package constructed at least in part of one or more olefins, and, more specifically, spunbounded polyolefins, such that, on the one hand, the absolute “sealability” and the mechanical cohesion of the two strips of the package remains in tact under expected conditions, and that, on the other hand, the two strips can nevertheless be easily peeled apart from each other in a manner that minimizes fiber tear-out.

The present invention provides a package, for example, for use with surgical instruments and other sterile-packed products, comprising one or more olefins (e.g., ethylene), and, more specifically, one or more spunbounded polyolefins (e.g., Tyvek™ 2FS™). The package preferably includes two strips of material that surround at least one cavity formed when the sheets are joined (e.g., via sealing). When sealed together, the sheets preferably include a projection or similar region to facilitate the process of peeling the joined sheets apart. The sealed edges (i.e., the joined region of the margin areas) to be opened include at least two uniformly distributed groups of bonding elements. The first group of sealing elements is comprised of relatively small-dimensioned elements, positioned in at least one direction in the plane of the edge. The second group of sealing elements is comprised of considerably longer lines of elements having limited width, positioned such that the lines run substantially transversely to the expected direction of peel.

Non-paper materials as a component of sterile-packed packages are favored for at least the following reasons: superior inner bond strength; superior tear resistance; low fiber tear; and improved porosity. Use of such materials substantially decreases any delamination of uncoated polyolefin materials upon opening of a package. Additionally, there is a diminished need for coating such materials, thereby greatly reducing associated costs. Moreover, use of such materials (versus paper products) provides the ability to longitudinally cut through the sealed area, thereby reducing the need for an unsealed area (apron), which in turn allows the package to have a wider seal and/or a larger inner cavity for containment of products.

The present invention recognizes and takes advantage of the discovery that there is no appreciable additional expenditure over conventional sealing methods and systems to use various sealing elements adopted for joining the two material strips. In this context, the arrangement of the multiple groups of sealing elements is flexible, allowing any desired shape(s) of packages to be produced. For example, the sealing bars and the counter-bearers for these groups can be manufactured as plate-like blanks. From these blanks, the desired forms can be produced. Alternatively, a specific tool for each desired package type and/or size is manufactured.

The first group of sealing elements is preferably laid out uniformly, each element of which is of relatively small dimension. The combination of uniform coverage with relative size reduces, if not eliminates, tear out of fibers. Separating a seal formed with such elements significantly reduces, if not eliminates, the risk of fiber tear since the forces transmitted from the sealing elements to the fibers are too limited to overcome the cohesion forces of the fibers in the bonded fibers. Additionally, since, generally, the fibers associated with the strip material are considerably longer than the individual dimensions of the sealing elements of the first group, even if portions of a fiber are dislodged, the fiber overall remains attached to the strip material. Alternatively, if portions of the fiber are actually separated from the strip material, they are generally small enough to be retained on the sealing elements that dislodged them. In either case, no fibers are dislodged and released during peeling.

The second group of sealing elements of the present invention provides the mechanical cohesion between the two strips of material comprising the package. As a result, the second group of sealing elements is not intended to produce an adequate degree of “sealability,” and can therefore be designed accordingly. The second group of sealing elements comprises elements of a general linear shape having a limited width. This relatively narrow dimension would not be sufficient alone to effectuate a proper seal. The second group of sealing elements also is positioned such that no disadvantageous effects occur upon peeling. The present invention achieves this by positioning the elements of the second group to run substantially transversely to the expected direction of peel. If the linear elements of the second group were aligned to run in the general direction of the peel, such sealing elements would likely tear out rows of fibers or lumps of fibers during peeling. Since the linear elements of the second group are arranged substantially transversely to the expected direction of the peel, only a relatively limited width of the strip is affected by the elements of this group during peeling. Any fibers that are actually dislodged (those that run virtually parallel to the linear elements) are retained by the sealing elements, thus preventing release of such fibers. Fibers that run transversely to the linear elements are, in contrast, only slightly affected, if at all, and are therefore not dislodged.

Through testing, the present invention recognizes that the most advantageous performance of the linear elements of the second group occurs when the linear elements of the second group of sealing elements do not run exactly at right angles to the direction of peel, but rather form an acute angle with the expected direction of peel. Use of an acute angle results in both a reduction of the tear-out forces during peeling, and a uniformity of peeling operation.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a plan view of a package formed in accordance with the present invention;

FIG. 2 is an alternative embodiment of a package formed in accordance with one embodiment of the present invention;

FIG. 3 is a sectional view corresponding to the section line III--III of FIG. 2; and

FIG. 4 is a magnified plan view of a package formed in accordance with another embodiment of the present invention.

Like reference symbols in the various drawings indicate like elements.

### DETAILED DESCRIPTION

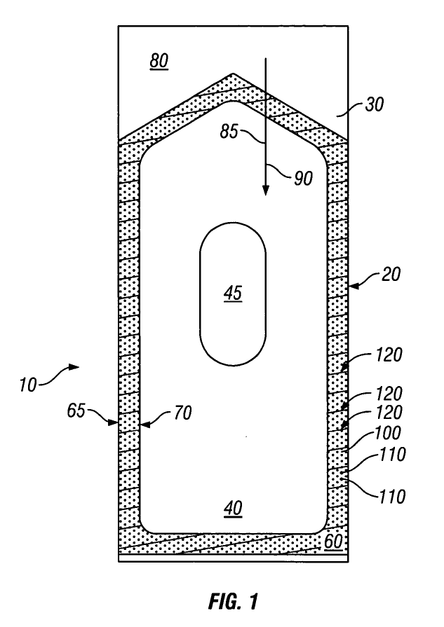

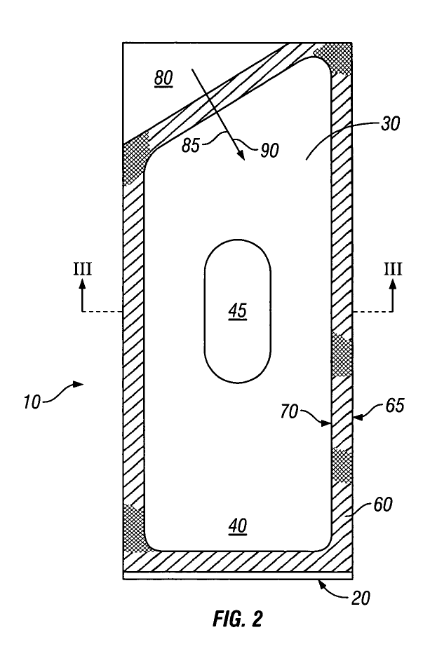

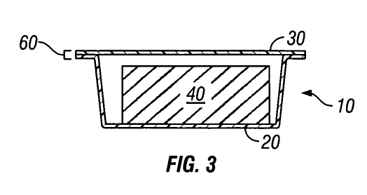

Referring now to FIGS. 1 and 3, there is shown a package 10 formed in accordance with one embodiment of the present invention in plan view and in cross section (FIG. 3 is a sectional view corresponding to the section line III--III of FIG. 2), respectively. The package 10 comprises a bottom sheet 20 and a top sheet 30. A cavity 40 is formed within the bottom sheet 20 to receive one or more items 45 (FIG. 1) to be contained by the package 1 0. Although a single cavity 40 of a generally rectangular shape is shown and described, it is noted that any number and/or shapes and/or sizes of cavities can be used in connection with the present invention, as desired, and all such combinations thereof are contemplated by the present invention.

Once one or more items 45 are placed within the cavity 40, the top sheet 30 covers the items and is bound to the bottom sheet 20 via sealing. In a preferred embodiment, the top sheet 30 is preferably constructed of a non-paper material having sufficient gas permeability characteristics. Examples of such materials include olefins, such as spunbounded polyolefin substrates. One example of an spunbounded polyolefin substrate suitable for use with this embodiment of the present invention is DuPont® Tyvek™ 2FS™ material. Spunbounded polyolefin materials function well as a component material for packages made in accordance with the present invention, but provide different sealing and peeling challenges than those associated with paper and paper-like materials. The present invention package 10 provides sealing and peeling functionality that allows such olefin materials to achieve desired sealing and peeling characteristics, thereby producing a superior package when compared to those made with paper or paper-like materials.

At a surrounding margin of the package 10, the bottom sheet 20 and the top sheet 30 are bonded with each other to form a joined region 60, preferably by sealing, utilizing methods and/or tools known in the industry for forming same. For example, sealing can occur via the application of heat, such as steam, and/or mechanical force. Sealing tools known in the industry can be utilized. Although the application of heat and/or force via known tools is described herein, it is noted that sealing by any suitable means and employing any suitable tools can be used, if desired, and such use is contemplated by the present invention.

The joined region 60 of the package 10 is bordered by parallel contours 65 and 70, whereby the contour 65 essentially forms the outer edge of the package 10, while the contour 70 simultaneously defines the inner edge of the package 10 and the outer edge of cavity 40. The joined region 60 can have substantially the same width around the perimeter of the package 10, or can have varying widths along the perimeter of the package 10, as desired. As shown in FIGS. 1 and 2, embodiments of the present invention can include a joined region 60 that totally surrounds the cavity 40 and that is generally similar in shape and width throughout the package 10. However, embodiments of the present invention can include a joined region 60 that surrounds less than the entire cavity 40 of the package 10 and/or that is dissimilarly shaped/sized throughout the package 10, if desired. It is noted that embodiments of the package 10 including a joined region 60 that surrounds less than the entire cavity 40 may be desired where it is preferable for the top sheet 30 to stay attached to the package 10 following peeling.

Generally, a width of approximately 5 millimeters is sufficient for the width of the joined region 60. However, varying widths, either uniformly or dispersed over the entire surface of the joined region 60, can be utilized, if desired. It is noted that utilizing the unique features of the present invention package 10, widths of less than 5 millimeters for the joined region 60 can be employed, if desired. The use of such reduced widths for the joined region 60 will result in increased space for use in the cavity(ies) 40 of the package 10.

Referring again to FIG. 1, the package 10 includes a tab region 80. The tab region 80 represents an area where the top sheet 30 and the bottom sheet 20 are not bound together. Gripping the tab region 80 allows one to easily initiate the peeling of the top sheet 30 from the bottom sheet 20 to gain access to the item(s) stored within the cavity 40. It is noted that, depending upon a number of factors, the presence, size and shape of the tab region 80 can vary (e.g., FIG. 2). For example, in some embodiments no tab region 80 may be desired. In such embodiments the very edges of top sheet 30 and bottom sheet 20 could be used to initiate peeling action to separate the sheets and access the item(s) contained within the package 10. One or more tab regions 80 could also be placed at virtually any point along the package, most likely, but not exclusively, along the perimeter of the package 10.

In FIGS. 1 and 2, an expected direction of peel 85 is shown via arrow 90. This direction represents the direction that peeling optimally occurs. In other words, a user optimally separates the top sheet 30 from the bottom sheet 20 by peeling in the direction of the expected direction of peel 85 (arrow 90). This is not to suggest that peeling is restricted to the expected direction of peel 85, but merely that such direction is optimal and therefore is expected. As detailed below, the expected direction of peel 85 is important to the functionality of the present invention package 10.

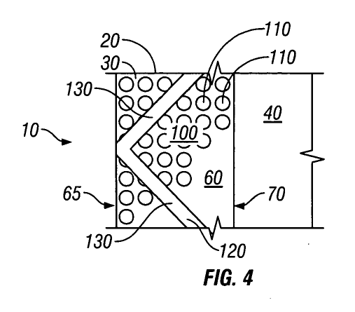

Now referring to FIG. 4, the package 10 of another embodiment of the present invention includes a first sealing group 100 associated with the joined region 60. The first sealing group 100 is preferably comprised of first sealing elements 110, each element of which has relatively small dimensions. Examples of such first sealing elements 110 include small circles, squares, triangles, dots, whether “hollow” or “filled”, and the like. Although representative shapes of the first sealing elements 110 have been described herein, it is noted that any suitable shape, or combination of shapes, could be employed, if desired.

Additionally, placement of the first sealing elements 110 within the joined region 60 is preferably relatively uniform. As will be explained, such uniform placement aids in the reduction of fiber tear out upon separation of the bottom sheet 20 and the top sheet 30 to access the cavity 40. Although uniform placement of the first sealing elements 110 is described herein, any suitable placement of the first sealing elements can be employed, if desired. The relative shape, number and placement (including distance between each element) of the first sealing elements 110 are used to provide a tight, but not flat, seal. Flat seals are to be avoided since they transfer large fiber tear out forces.

The combination of uniform placement and relative size of the first sealing elements 110 reduces, if not eliminates, tear out of fibers associated with the top sheet 30 and/or the bottom sheet 20. Reduction, if not elimination, of fiber tear-out occurs since the forces transmitted from the first sealing elements 110 to any fibers within the top sheet 30 and/or the bottom sheet 20 are too limited to overcome the cohesion forces of such fibers with the larger material. Additionally, since, generally, fibers associated with strip material are considerably longer than the individual dimensions of the first sealing elements 110, even if portions of a fiber are dislodged, the fiber overall remains attached to the strip material. Alternatively, if portions of the fiber are actually separated from the strip material, they are generally small enough to be retained on the first sealing elements 110 that dislodged them. In either case, no fibers are dislodged and released during peeling.

The package 10 of this embodiment further includes a second sealing group 120 associated with the joined region 60. The second sealing group 120 is preferably comprised of second sealing elements 130 having a generally linear shape of relatively narrow width (preferably less than 2 mm in width). Examples of such second sealing elements 130 include lines, continuous and broken (e.g., dashes, zig-zags), whether “hollow” or “filled”, and the like. Although representative shapes of the second sealing elements 130 have been described herein, it is noted that any suitable shape, or combination of shapes, could be employed, if desired.

Referring now to FIGS. 1 and 4, the second sealing group 120 of the present invention provides mechanical cohesion between the top sheet 30 and the bottom sheet 20 comprising the package 10. As a result, the second sealing group 120 is not intended to produce an adequate degree of “sealability” for the package 10, and can therefore be designed accordingly. Importantly, the second sealing elements 130 are positioned within the joined region 60 to run substantially transverse with respect to the expected direction of peel 85 (arrow 90). If the substantially linear shape(s) of the second sealing elements 130 were aligned to run in the general direction of the expected peel 85 (arrow 90), said second sealing elements 130 would likely tear out fibers associate with the top sheet 30 and/or the bottom sheet 20 during peeling. Since the second sealing elements 130 are arranged substantially transversely to the expected direction of the peel 85 (arrow 90), only a relatively limited portion of the top sheet 30 and/or bottom sheet 20 is affected by the second sealing elements 130 during peeling. Any fibers that are actually dislodged (e.g., those that run virtually parallel to the second sealing elements 130) are retained by the second sealing elements 130, thus preventing release of such fibers. Fibers that run transversely to the second sealing elements 130 are, in contrast, only slightly affected, if at all, and are therefore not dislodged.

In a preferred embodiment, the second sealing elements 130 form one or more acute angles with respect to the expected direction of peel 85 (arrow 90). Use of one or more acute angles results in both a reduction of the tear-out forces during peeling, and a uniformity of peeling operation. Although substantially transverse orientation of the second sealing elements 130 is described, orientation of the second sealing elements 130 with respect to the expected direction of peel 85 (arrow 90) at any one or more acute angles is contemplated by the present invention. As shown in FIGS. 1, 2 and 4, the second sealing elements 130 can be arranged in repeating or “zig-zag” patterns. Such patterns are described as representative patterns. Any suitable pattern, or combination of patterns, may be utilized, if desired.

In operation, one of more items 45 to be contained by the package 10 is placed within the cavity 40. The top sheet 30 is then placed over the bottom sheet 20 and sealing of the two materials is accomplished. Alternatively, the seal item(s) can be sterilized by subjecting the package 10 to known methods of sterilization. Such methods can include the application of thermal energy (e.g., steam) and/or the introduction of one of more gases, as desired. It is noted that the application of thermal energy can have deleterious effects on certain items within the package 10. As a result, the use of one of the gases (e.g., a germicidal gas) can be employed. In the event one of more gases are used to provided sterilization, the component materials of the package 10 must facilitate gas exchange between the interior and exterior environments of the cavity 40 of the package 10. For example, a top sheet 30 having gas permeability characteristics can be employed.

Once access to the item(s) contained within the package 10 is desired, the top sheet 30 and the bottom sheet 20 are separated from each other by a peeling action that is preferably initiated at the optional tab region 80. Optimally, the top sheet 30 and the bottom sheet 20 are peeled apart in the expected direction of peel 85 (arrow 90), such that fiber tear-out forces are reduced, any dislodged fibers are retained, and peeling is uniform. Depending upon the design and placement of the first sealing group 100 and the second sealing group 120, the top sheet 30 can be removed and discarded apart from the package 10, or is retained with the package 10 for disposal.

A number of embodiments of the invention have been described. Nevertheless, it will be understood that various modifications may be made without departing from the spirit and scope of the invention. For example, an embodiment of the present invention package employing more than two groups of sealing elements could be utilized. Accordingly, other embodiments are within the scope of the following claims.

What is claimed is:

1. A package comprising:
a first sheet of a plastic material;
a second sheet of a non-paper material;
a cavity formed by joining said first sheet and said second sheet, said cavity capable of receiving and containing one or more items; and
at least one joined region formed by joining said first sheet and said second sheet;
said at least one joined region including a first group of sealing elements and a second group of sealing elements.

2. The package of claim 1, wherein the first material and the second material are the same material.

3. The package of claim 1, wherein the first material and the second material are different.

4. The package of claim 1, wherein the non-paper material is at least one olefin.

5. The package of claim 4, wherein the at least one olefin is a polyolefin.

6. The package of claim 5, wherein the polyolefin is spunbounded.

7. The package of claim 4, wherein the at least one olefin is uncoated.

8. The package of claim 4, wherein the at least one olefin is Tyvek™ 2FS™.

9. The package of claim 1, wherein the first sheet and the second sheet are joined via sealing.

10. The package of claim 1, wherein the at least one joined region substantially surrounds the cavity.

11. The package of claim 1, wherein said first group of sealing elements includes at least two first sealing elements and said second group of sealing elements includes at least two second sealing elements.

12. The package of claim 11, wherein the at least two first sealing elements are uniformly dispersed on the at least one joined region.

13. The package of claim 11, wherein the at least first two sealing elements have relatively small dimensions when compared with the at least two second sealing elements.

14. The package of claim 11, wherein the at least two second sealing elements are uniformly dispersed on the at least one joined region.

15. The package of claim 11, wherein the at least two second sealing elements are positioned on the at least one joined region at an at least one angle with respect to an expected direction of pull associated with peeling apart the first sheet and the second sheet.

16. The package of claim 11, wherein the at least two first sealing elements and the at least two second sealing elements overlap on the at least one joined region.

17. The package of claim 11, wherein the at least two first sealing elements and the at least two second sealing elements do not overlap on the at least one joined region.

18. A package comprising:
a first sheet of a plastic material;
a second sheet of least one spunbounded polyolefin;
a cavity formed by joining said first sheet and said second sheet, said cavity capable of receiving and containing one or more items; and
at least one joined region formed by joining said first sheet and said second sheet;
said at least one joined region including a first group of sealing elements and a second group of sealing elements.

19. The package of claim 18, wherein the at least one spunbounded polyolefin is Tyvek™ 2FS™.

20. The package of claim 18, wherein the second group of sealing elements are positioned on the at least one joined region at an acute angle with respect to an expected direction of pull associated with peeling apart the first sheet and the second sheet.
